(19) United States
(12) Patent Application Publication
(10) Pub. No.: US 2024/0353834 A1
(43) Pub. Date: Oct. 24, 2024

(54) INTELLIGENT VEHICLES, SYSTEMS, AND CONTROL LOGIC FOR EXTERNAL CONTROL OF VEHICLES USING VISIBLE OR AUDIBLE CUES

(71) Applicant: GM GLOBAL TECHNOLOGY OPERATIONS LLC, Detroit, MI (US)

(72) Inventors: Umer Khalid, Farmington Hills, MI (US); Russell A. Patenaude, Macomb Township, MI (US); Suresh Munagapati, Cumming, GA (US); Jeremy A. Salinger, Southfield, MI (US)

(73) Assignee: GM GLOBAL TECHNOLOGY OPERATIONS LLC, Detroit, MI (US)

(21) Appl. No.: 18/304,431

(22) Filed: Apr. 21, 2023

(51) Int. Cl. G05D 1/00; B60W 60/00; G06F 3/01; G06F 3/16

(52) U.S. Cl. CPC G05D 1/0016; B60W 60/001; G06F 3/017; G06F 3/167

(57) ABSTRACT

Presented are intelligent vehicle control systems enabling external control of vehicles using visible or audible cues, methods for making/using such vehicle control systems, and motor vehicles equipped with such control systems. A method of controlling operation of a vehicle includes a vehicle controller receiving a trigger signal indicating the vehicle is in an automatic control trigger state and, responsive to receiving the trigger signal, activating an automatic control mode that enables an entity outside the vehicle to control the vehicle using visible and/or audible cues. The vehicle controller determines if an on-vehicle network of sensing devices detects a visible/audible cue from the external entity; if so, the controller responsively determines if the detected visible/audible cue is a preset valid command. If the detected visible/audible cue is a valid command, the vehicle controller responsively commands a resident subsystem of the vehicle to automate a vehicle operation corresponding to the valid command.

### INTRODUCTION

The present disclosure relates generally to intelligent control systems of motor vehicles. More specifically, aspects of this disclosure relate to systems, methods, and devices for provisioning automated vehicle control using visible or audible cues.

Motor vehicles, such as automobiles, may be equipped with a network of onboard electronic devices that provide automated driving capabilities to help minimize driver effort. In automotive applications, for example, one of the most recognizable types of automated driving features is the cruise control system. Cruise control allows a vehicle operator to set a particular vehicle speed and have the onboard vehicle computer system maintain that speed without the driver operating the accelerator or brake pedals. Next-generation Adaptive Cruise Control (ACC) is an automated driving feature that regulates vehicle speed while concomitantly managing headway spacing between the host vehicle and a leading “target” vehicle. Another type of automated driving feature is the Collision Avoidance System (CAS), which detects imminent collision conditions and provides a warning to the driver while also taking preventative action autonomously, e.g., by steering or braking without driver input. Intelligent Parking Assist Systems (IPAS), Lane Monitoring and Automated Steering (“Auto Steer”) Systems, Electronic Stability Control (ESC) systems, and other Advanced Driver Assistance Systems (ADAS) are also available on many automobiles.

As vehicle processing, communication, and sensing capabilities continue to improve, manufacturers will persist in offering more automated driving capabilities with the aspiration of producing fully autonomous “self-driving” vehicles competent to operate among heterogeneous vehicle types in both urban and rural scenarios. Original equipment manufacturers (OEM) are moving towards vehicle-to-vehicle (V2V) and vehicle-to-infrastructure (V2I) “talking” cars with higher-level driving automation that employ intelligent control systems to enable vehicle routing with steering, lane changing, scenario planning, etc. Automated path planning systems utilize vehicle state and dynamics sensors, geolocation information, map and road condition data, and path prediction algorithms to provide route derivation with automated lane center and lane change forecasting.

Many automobiles are equipped with an in-vehicle telecommunications and informatics (“telematics”) unit that provides vehicle navigation, control, entertainment, and other desired functionalities. Wireless-enabled telematics units, in addition to enabling vehicle occupants to connect to the Internet and communicate with a centralized back-office (BO) host vehicle service, may enable an owner or driver of the vehicle to interact with the telematics unit via a cellular or short-range comm link using a smartphone or similar device. For instance, the owner/driver may misplace the keys to the vehicle or lock the keys inside the vehicle; the user may use their smartphone to communicate with the telematics unit to unlock a vehicle door. Additionally, an owner/driver who forgets where they parked the vehicle in a parking garage may wirelessly communicate with the telematics unit using their smartphone to activate the vehicle's horn and/or car lights. Generally speaking, wireless communications with and remote control of a vehicle is typically limited to the vehicle owner or an authorized driver of the vehicle and necessitates a wireless-enabled computing device and prior user authentication.

### SUMMARY

Presented herein are intelligent vehicle systems with attendant control logic for provisioning external control of vehicles using visible and audible cues, methods for making and methods for operating such vehicle control systems, and motor vehicles equipped with such control systems. By way of example, there is presented a system and method for controlling a vehicle externally using signs, sounds, verbal commands, gestures, etc. The method may enable dynamic assignment of external vehicle control to previously registered or unregistered third parties, first responders, and preauthorized users, such as a vehicle owner or driver. Under exigent circumstances, such as a vehicle collision event or an emergency situation, the vehicle control system may enable a person standing outside the host vehicle to safely and securely move the vehicle using hand motions, verbal commands, or other visible/audible inputs that are perceptible by the vehicle's networked sensor array. One of three different operating modes—automatic, manual, and remote—may be triggered to assign distinct levels of vehicle control based on vehicle sensor feedback, contextual data, vehicle state, remote user identify, etc. Limitations of pre-authorization for specific individuals or credential exchanges on a device may be eliminated by utilizing a flexible algorithm that determines when and to what extent the functionality is necessary.

Attendant benefits for at least some of the disclosed concepts include enhanced vehicle control protocols that dynamically enable external control of a host vehicle using visible and/or audible cues without requiring prior authentication or recognition of the cue-generating entity. Disclosed vehicle control protocols enable a first responder or pedestrian to gain access to and/or safely relocate a host vehicle during any one of multiple predefined urgent situations without the need for a wireless-enabled computing device or access to the passenger compartment. Other attendant benefits may include control protocols that enforce a hierarchy of command authority, such as different operating modes assigned distinct levels of command with associated sets of authorized controls. The enforced hierarchy helps the host vehicle to dynamically expand or restrict external user control. The vehicle may enable an external entity to submit a formal request or enter a predefined gesture or a set of credentials for enhanced control approval. If a preset threshold of identification is not met, the host vehicle or a remote authorization unit may restrict or deny external control.

Aspects of this disclosure are directed to intelligent vehicle control systems, system control logic, and memory-stored instructions for provisioning external control of vehicles using visible and audible cues. In an example, a method is presented for controlling operation of a host vehicle having a resident or remote controller or module or network of controllers/modules (collectively “controller” or “vehicle controller”) and an on-vehicle network of sensing devices (e.g., radar transceiver(s), LiDAR scanner(s), high-definition video camera(s), etc.). This representative method includes, in any order and in any combination with any of the above and below disclosed options and features: receiving. e.g., via the vehicle controller from an in-vehicle telematics unit, an automatic trigger signal indicating the host vehicle is in any one of multiple predefined automatic control trigger states; activating, e.g., via the vehicle controller in cooperation with an ADAS module responsive to receiving the automatic trigger signal, an automatic control mode that enables an entity outside the host vehicle to control the host vehicle using visible and/or audible cues; determining, e.g., via the vehicle controller, if at least one sensor in the network of sensing devices detects a visible/audible cue from the external entity and outputs a sensor signal indicative thereof; determining, e.g., via the vehicle controller responsive to receiving the sensor signal, if the detected visible/audible cue is any one of multiple preset valid commands; and transmitting, e.g., via the vehicle controller responsive to the detected visible/audible cue being a preset valid command, one or more command signals to one or more resident vehicle subsystems of the host vehicle to automate one or more vehicle operations corresponding to the preset valid command (e.g., reposition host vehicle, unlock host vehicle, lower vehicle window, disconnect vehicle battery pack, etc.).

Aspects of this disclosure are also directed to computer-readable media (CRM) for enabling external control of vehicles using visible and audible cues. In an example, a non-transitory CRM stores instructions that are executable by one or more processors of a vehicle controller. When executed by the processor(s), these instructions cause the controller to perform operations, including: receiving an automatic trigger signal indicating a host vehicle is in any one of multiple predefined automatic control trigger states; activating, responsive to receiving the automatic trigger signal, an automatic control mode enabling an external entity outside the host vehicle to control the host vehicle using a visible and/or audible cue; receiving, from a network of sensing devices of the host vehicle, a sensor signal indicating detection of the visible and/or audible cue from the external entity; determining if the detected visible and/or audible cue is a preset valid command; and transmitting, responsive to the detected visible and/or audible cue being the preset valid command, a command signal to a resident vehicle subsystem of the host vehicle to automate a vehicle operation corresponding to the preset valid command.

Additional aspects of this disclosure are directed to motor vehicles with intelligent control systems that provision external vehicle control using signs, gestures, verbal commands, etc. As used herein, the terms “vehicle” and “motor vehicle” may be used interchangeably and synonymously to include any relevant vehicle platform, such as passenger vehicles (ICE, HEV, FEV, fuel cell, fully or partially autonomous, etc.), commercial vehicles, industrial vehicles, tracked vehicles, off-road and all-terrain vehicles, motorcycles, farm equipment, watercraft, aircraft, etc. In an example, a motor vehicle includes a vehicle body with a passenger compartment, multiple road wheels mounted to the vehicle body (e.g., via corner modules coupled to a unibody or body-on-frame chassis), and other standard original equipment. A vehicle powertrain with a prime mover, such as an internal combustion engine (ICE) assembly and/or an electric traction motor, drives one or more of the road wheels to propel the vehicle. A network of sensing devices is distributed across the vehicle body and communicates sensor data to a resident or remote vehicle controller to help govern operation of the motor vehicle.

Continuing with the preceding discussion, the vehicle controller is programmed to receive an automatic trigger signal that indicates the motor vehicle is in any one of multiple predefined automatic control trigger states and, responsive to receiving this trigger signal, activate an automatic control mode that enables an entity outside the vehicle to control the vehicle using visible and/or audible cues. The controller then determines if the on-vehicle network of sensing devices detects a visible/audible cue from the external entity; if so, the controller responsively determines if the detected visible/audible cue is a preset valid command. Upon determining that the detected visible/audible cue is a valid command, the controller responsively commands one or more resident vehicle subsystems of the motor vehicle to automate one or more vehicle operations corresponding to the preset valid command.

For any of the disclosed vehicles, methods, and CRM, the vehicle controller may respond to the detected visible/audible cue not being a valid command by communicating with the network of sensing devices to receive a new sensor signal indicating detection of a new visible/audible cue from the external entity. Once detected, the controller determines if this new visible/audible cue is one of the predefined valid commands; if so, the controller responsively commands one or more of the resident vehicle subsystems to automate a vehicle operation corresponding to that valid command. Determining whether or not a visible/audible cue has been detected may include determining whether or not the network of sensing devices detects a visible and/or audible cue within a preset timeframe. In this instance, the vehicle controller may conclude a visible/audible cue is not detected when the sensors have not detected a visible/audible cue within the preset timeframe. Upon concluding that a visible/audible cue is not detected, the vehicle controller may responsively deactivate the automatic control mode.

For any of the disclosed vehicles, methods, and CRM, the vehicle controller, after commanding the resident vehicle subsystem(s) to automate the vehicle operation(s), may communicate with the sensing devices to receive a new sensor signal indicating detection of a new visible/audible cue from the external entity. The controller then determines if this new visible/audible cue is any one of multiple preset valid commands; if so, the controller may responsively command the resident vehicle subsystem(s) to automate one or more new vehicle operation(s) corresponding to the preset valid command. As another option, the vehicle controller may respond to not receiving an automatic trigger signal by receiving a manual trigger signal indicating the host vehicle received any one of multiple predefined manual trigger inputs. In this instance, the controller may respond to receiving the manual trigger signal by activating a manual control mode, distinct from the automatic control mode, that enables the external entity to control the host vehicle using visible and/or audible cues. For example, the automatic control mode may include a distinct (first) set of vehicle operations triggerable by visible/audible cue from an external entity, whereas the manual control mode includes another distinct (second) set of vehicle operations that are triggerable by visible/audible cues from the external entity. The manual trigger input may include the host vehicle detecting a predefined gesture or a preauthorized code and/or receiving in-vehicle approval from an occupant of the host vehicle.

For any of the disclosed vehicles, methods, and CRM, the vehicle controller may respond to not receiving an automatic or manual trigger signal by receiving a remote trigger signal that indicates the host vehicle received approval for external vehicle control from a remote vehicle command center (e.g., ONSTAR® or MYGMC®). In this instance, the vehicle controller may respond to receiving the remote trigger signal by activating a remote control mode that is distinct from both the manual and automatic control modes. For instance, the remote control mode may enable the command center to control the host vehicle using wirelessly transmitted control signals. The remote control mode may also enable an external entity to control the host vehicle using visible and/or audible cues. For example, the remote control mode may include a distinct (third) set of vehicle operations, which is different from the vehicle operation sets of the automatic and manual control modes, executable by the command center or triggerable by visible/audible cue from an external entity. The remote trigger signal may be generated in response to a telephone call between a remote vehicle command center and a cellular-enabled computing device of the external entity or a telematics unit in the host vehicle's passenger compartment.

For any of the disclosed vehicles, methods, and CRM, the vehicle controller may respond to activating the automatic control mode by activating a vehicle light system and/or a vehicle audio system of the host vehicle to output a predefined visible and/or audible confirmation indicating to the external entity that the automatic control mode is activated. As another option, the predefined automatic control trigger state may include the host vehicle being in a vehicle collision state (e.g., SOS call placed by telematics unit, airbag or pretensioner deployed, etc.), the host vehicle being in a vehicle incapacitated state (e.g., thermal runaway event detected), and/or the host vehicle being positioned within a predefined location (e.g., geopositional data indicates host within predefined geofence, manufacturer's warehouse, car dealer's lot, etc.).

The above summary does not represent every embodiment or every aspect of the present disclosure. Rather, the foregoing summary merely provides a synopsis of some of the novel concepts and features set forth herein. The above features and advantages, and other features and attendant advantages of this disclosure, will be readily apparent from the following Detailed Description of illustrated examples and representative modes for carrying out the disclosure when taken in connection with the accompanying drawings and appended claims. Moreover, this disclosure expressly includes any and all combinations and subcombinations of the elements and features presented above and below.

### BRIEF DESCRIPTION OF THE DRAWINGS

FIG. 1 is a partially schematic, side-view illustration of a representative intelligent motor vehicle with a network of in-vehicle controllers, sensing devices, and communication devices for provisioning enhanced remote vehicle control by an external entity in accord with aspects of the present disclosure.

FIG. 2 is a flowchart illustrating a representative vehicle control algorithm for provisioning external operation of a vehicle using visible or audible cues, which may correspond to memory-stored instructions that are executable by a resident or remote controller, control-logic circuit, programmable control unit, or other integrated circuit (IC) device or network of devices in accord with aspects of the disclosed concepts.

The present disclosure is amenable to various modifications and alternative forms, and some representative embodiments of the disclosure are shown by way of example in the drawings and will be described in detail herein. It should be understood, however, that the novel aspects of this disclosure are not limited to the particular forms illustrated in the above-enumerated drawings. Rather, this disclosure covers all modifications, equivalents, combinations, permutations, groupings, and alternatives falling within the scope of this disclosure as encompassed, for example, by the appended claims.

### DETAILED DESCRIPTION

This disclosure is susceptible of embodiment in many different forms. Representative embodiments of the disclosure are shown in the drawings and will herein be described in detail with the understanding that these embodiments are provided as an exemplification of the disclosed principles, not limitations of the broad aspects of the disclosure. To that extent, elements and limitations that are described, for example, in the Abstract, Introduction, Summary, and Detailed Description sections, but not explicitly set forth in the claims, should not be incorporated into the claims, singly or collectively, by implication, inference or otherwise. Moreover, recitation of “first”, “second”, “third”, etc., in the specification or claims is not used to establish a serial or numerical limitation; rather, these designations may be used for ease of reference to similar features in the specification and drawings and to demarcate between similar elements in the claims.

For purposes of the present detailed description, unless specifically disclaimed: the singular includes the plural and vice versa; the words “and” and “or” shall be both conjunctive and disjunctive; the words “any” and “all” shall both mean “any and all”; and the words “including,” “containing,” “comprising,” “having,” and the like, shall each mean “including without limitation.” Moreover, words of approximation, such as “about,” “almost,” “substantially,” “generally,” “approximately,” and the like, may each be used herein in the sense of “at, near, or nearly at,” or “within 0-5% of,” or “within acceptable manufacturing tolerances,” or any logical combination thereof, for example. Lastly, directional adjectives and adverbs, such as fore, aft, inboard, outboard, starboard, port, vertical, horizontal, upward, downward, front, back, left, right, etc., may be with respect to a motor vehicle, such as a forward driving direction of a motor vehicle when the vehicle is operatively oriented on a horizontal driving surface.

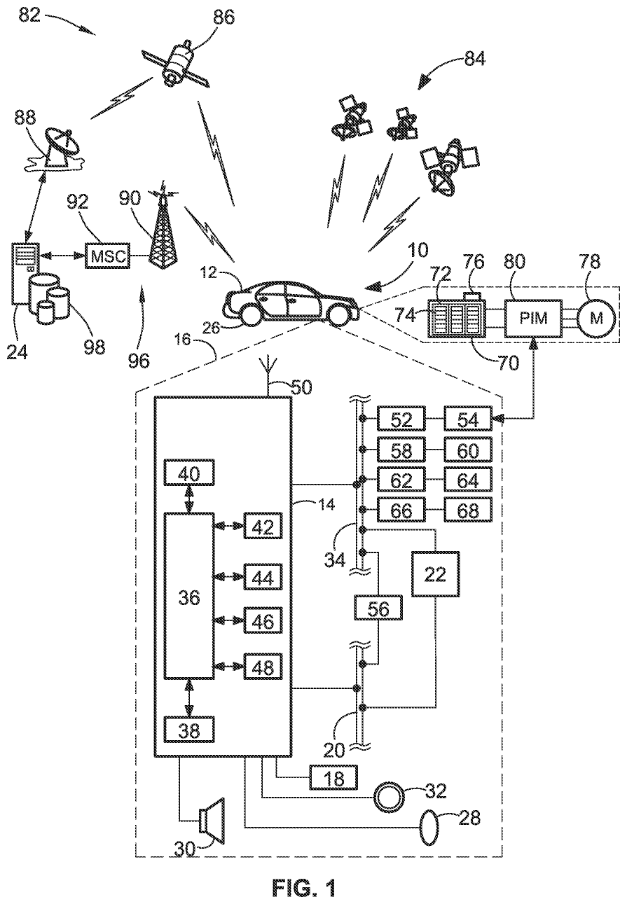

Referring now to the drawings, wherein like reference numbers refer to like features throughout the several views, there is shown in FIG. 1 a representative motor vehicle, which is designated generally at 10 and portrayed herein for purposes of discussion as a sedan-style, electric-drive automobile. The illustrated automobile 10—also referred to herein as “motor vehicle” or “vehicle” for short—is merely an exemplary application with which aspects of this disclosure may be practiced. In the same vein, incorporation of the present concepts into the illustrated wireless communications network for cellular and mesh-enabled “talking” cars should also be appreciated as a non-limiting implementation of disclosed features. As such, it will be understood that novel aspects and features of this disclosure may be applied to other wireless network architectures, implemented for a myriad of different triggering events, and incorporated into any logically relevant type of vehicle. Moreover, only select components of the motor vehicles and intelligent vehicle control systems are shown and described in additional detail herein. Nevertheless, the vehicles and systems discussed below may include numerous additional and alternative features, and other available peripheral components, for carrying out the various methods and functions of this disclosure.

The representative vehicle 10 of FIG. 1 is originally equipped with a vehicle telecommunications and information (“telematics”) unit 14 that wirelessly communicates, e.g., via cell towers, base stations, mobile switching centers, satellite service, etc., with a remotely located back-office (BO) cloud computing host service 24 (e.g., ONSTAR®). Some of the other vehicle hardware components 16 shown generally in FIG. 1 include, as non-limiting examples, an electronic video display device 18, a microphone 28, audio speakers 30, and assorted user input controls 32 (e.g., buttons, knobs, switches, touchpads, joysticks, touchscreens, etc.). These hardware components 16 function, in part, as a human-machine interface (HMI) that enables a user to communicate with the telematics unit 14 and other components resident to and remote from the vehicle 10. Microphone 28, for instance, provides occupants with a means to input verbal or other auditory commands; the vehicle 10 employs an embedded voice-processing unit utilizing audio filtering, editing, and analysis modules to convert the inputs to signals. Conversely, the speakers 30 provide audible output to a vehicle occupant and may be either a stand-alone speaker dedicated for use with the telematics unit 14 or may be part of an audio system 22. The audio system 22 is operatively connected to a network connection interface 34 and an audio bus 20 to receive analog information, rendering it as sound, via one or more speaker components.

Communicatively coupled to the telematics unit 14 is a network connection interface 34, suitable examples of which include twisted pair/fiber optic Ethernet switches, parallel/serial communications buses, local area network (LAN) interfaces, controller area network (CAN) interfaces, and the like. The network connection interface 34 enables the vehicle hardware 16 to send and receive signals with one another and with various systems both onboard and off-board the vehicle body 12. This allows the vehicle 10 to perform assorted vehicle functions, such as modulating powertrain output, activating friction or regenerative brakes, controlling vehicle steering, managing operation of a traction battery pack, controlling vehicle windows, doors, and lock, and other automated functions. For instance, telematics unit 14 may exchange signals with a Powertrain Control Module (PCM) 52, an Advanced Driver Assistance System (ADAS) module 54, an Electronic Battery Control Module (EBCM) 56, a Steering Control Module (SCM) 58, a Brake System Control Module (BSCM) 60, and assorted other vehicle ECUs, such as a transmission control module (TCM), engine control module (ECM), Sensor System Interface Module (SSIM), etc.

With continuing reference to FIG. 1, telematics unit 14 is an onboard computing device that provides a mixture of services, both individually and through its communication with other networked devices. This telematics unit 14 is generally composed of one or more processors 40, each of which may be embodied as a discrete microprocessor, an application specific integrated circuit (ASIC), or a dedicated control module. Vehicle 10 may offer centralized vehicle control via a central processing unit (CPU) 36 that is operatively coupled to a real-time clock (RTC) 42 and one or more electronic memory devices 38, each of which may take on the form of a CD-ROM, magnetic disk, IC device, a solid-state drive (SSD) memory, a hard-disk drive (HDD) memory, flash memory, semiconductor memory (e.g., various types of RAM or ROM), etc.

Long-range communication (LRC) capabilities with off-board devices may be provided via one or more or all of a cellular chipset, an ultra-high frequency radio transceiver, a navigation and location component (e.g., global positioning system (GPS) transceiver), and/or a wireless modem, all of which are collectively represented at 44. Short-range communication (SRC) may be provided via a close-range communication device 46 (e.g., a BLUETOOTH® unit or near field communications (NFC) transceiver), UWB comm device, a dedicated short-range communications (DSRC) component 48, and/or a dual antenna 50. The communications devices described above may provision data exchanges as part of a periodic broadcast in a vehicle-to-vehicle (V2V) communications network or a vehicle-to-everything (V2X) communications network, e.g., Vehicle-to-Infrastructure (V2I), Vehicle-to-Pedestrian (V2P), Vehicle-to-Device (V2D), etc. It is envisioned that the vehicle 10 may be implemented without one or more of the above listed components or, optionally, may include additional components and functionality as desired for a particular end use.

CPU 36 receives sensor data from one or more sensing devices that use, for example, photo detection, radar, laser, ultrasonic, optical, infrared, or other suitable technology, including short range communications technologies (e.g., DSRC or BLUETOOTH® or BLE®) or Ultra-Wide Band (UWB) radio technologies, e.g., for executing an automated vehicle operation or a vehicle navigation service. In accord with the illustrated example, the automobile 10 may be equipped with one or more digital cameras 62, one or more range sensors 64, one or more vehicle speed sensors 66, one or more vehicle dynamics sensors 68, and any requisite filtering, classification, fusion, and analysis hardware and software for processing raw sensor data. The type, placement, number, and interoperability of the distributed array of in-vehicle sensors may be adapted, singly or collectively, to a given vehicle platform for achieving a desired level of automation and concomitant autonomous vehicle operation.

To propel the motor vehicle 10, an electrified powertrain is operable to generate and deliver tractive torque to one or more of the vehicle's drive wheels 26. The vehicle's electrified powertrain is generally represented in FIG. 1 by an electric traction motor 78 that is operatively connected to a rechargeable energy storage system (RESS), which may be in the nature of a chassis-mounted traction battery pack 70. The traction battery pack 70 may be generally composed of one or more battery modules 72 each containing a group of electrochemical battery cells 74, such as lithium ion, lithium polymer, or nickel metal hydride battery cells. Traction motor/generator (M) unit 78 draws electrical power from and, optionally, delivers electrical power to the battery pack 70. A power inverter module (PIM) 80 electrically connects the battery pack 70 to the motor/generator unit(s) 78 and modulates the transfer of electrical current therebetween. The battery pack 70 may be configured such that module management, cell sensing, and module-to-module or module-to-host communications functionality is integrated directly into each module 72 and performed wirelessly via a wireless-enabled cell monitoring unit (CMU) 76.

Also shown in FIG. 1 is a mobile vehicle communications (MVC) system 82 that enables wireless communications between remotely located computing nodes and one or more motor vehicles 10. MVC system 82 is represented herein by a constellation of GPS satellites 84, a wireless services satellite 86, an uplink transmitting station 88, a cellular (cell) transceiver tower 90, and a mobile switching center (MSC) 92. A host vehicle's GPS transceiver 44 may exchange radio signals with the GPS satellites 84 to derive real-time or near real-time geopositional and time data for the vehicle 10, which may be used to provide navigation and other related services to vehicle occupants. Wireless services satellite 86, through cooperative operation with the uplink transmitting station 88, provisions unidirectional and bidirectional communications with the vehicle 10, such as satellite radio and media services (e.g., music, news, videos, etc.) and satellite telephony services (e.g., to contact a remote vehicle command center). While shown with a single vehicle 10 communicating with multiple GPS satellites 84, a single wireless services satellite 86, a single uplink station 88, a single cell tower 90, and a single MSC 92, MVC system 82 may incorporate any number and combination of the foregoing elements as well as other available and hereafter developed communications hardware.

The MVC system 82 may operate within a cellular communications system 96, which is represented in FIG. 1 by one or more cell towers 90, one or more mobile switching centers 92, as well as any other networking components needed to link the cellular communications system 96 with assorted end nodes (e.g., BO host service 24). Each cell tower 90 may be equipped with a respective set of sending and receiving antennas for exchanging radio signals with vehicles 10. Base stations of the different cell towers may be connected to the MSC 92 either directly or via intermediary equipment, such as a base station controller (not shown). The cellular communications system 96 may implement any suitable communications technology, including earlier cellular protocols, such as cellular digital packet data (CDPD) 2G technologies, or contemporary cellular protocols, such as 4G-LTE of 5G-Advanced technologies. Vehicle telematics unit 14 may function as a cellular-enabled mobile component that is registered with a cellular carrier to transmit network data packets to and from the cellular communications system 96. It should be appreciated that the system 96 may take on innumerable tower/station/MSC arrangements, including co-location of a base station and a cell tower at the same site, remotely locating base stations and cell towers from one another, a single base station servicing a single cell tower, a single cell servicing multiple cell towers, and coupling multiple base stations to a single MSC, to name but a few possible arrangements.

In accord with disclosed concepts, it is oftentimes desirable to enable operation of a host vehicle by an individual located outside of the vehicle's passenger compartment, or a combination of inside and/or outside the vehicle, without the need for preauthorization of that individual or a wireless-enabled handheld computing device to input vehicle control commands. Discussed below are intelligent vehicle control systems and control logic for provisioning deviceless external command and control by third parties, e.g., in predefined urgent situations in which predicting the need for control and authorizing users ahead of time is not practical. Urgent situations may unexpectedly necessitate a person to command a vehicle from outside the vehicle using visible or audible commands. Some non-limiting examples of such “urgent” situations may include enabling law enforcement, armed services, paramedics, or any first responder to: reposition a vehicle during a riot or crowd control incident; access a passenger compartment or move a vehicle over to a roadway shoulder after a collision event; relocate a vehicle off railroad tracks, out of intersections, etc., to eliminate dangerous situations; move a vehicle with an officer to provide active protection and cover; move a vehicle to an open area when it is on fire or has the potential for one, etc. Disclosed vehicle control modes may also be utilized in non-urgent situations, such as by original equipment manufacturer (OEM) staff after vehicle roll-off from the production line (“pre-shipping mode”), by fleet staff during rental, delivery, or maintenance, by government staff or sales staff within a designated parking lot/garage or virtual geofence, etc. While not per se limited, aspects of this disclosure may be particularly relevant to Software Defined Vehicles (SDV) that manage vehicle operations, provision new vehicle functionality, and enable new in-vehicle user features primarily or entirely through software. SDVs are highly mechatronic intelligent devices that offer increased flexibility, customization, and remote upgradeability over their conventional counterparts.

By and large, many automobiles are not able to receive or approve commands from an external entity without some form of electronic device, wireless connectivity, and pre-defined assignment or authentication of the entity. Disclosed systems and methods reduce/eliminate these obstacles by using on-vehicle sensors, available vehicle condition and state data, contextual assessments, etc., to dynamically evaluate and enable an external entity to control the host vehicle. For instance, an intelligent vehicle control system may monitor for Obedience Mode triggers and, once received, attempt to detect an event that permits automatic approval. Some such examples include vehicle controller confirmation of: an automated collision event call to a BO host vehicle service/vehicle command center; an airbag/pretensioner/near deploy/low-level deployment event; a thermal runaway propagation (TRP) event; a remote vehicle slowdown; geopositional data indicating the vehicle is within a defined geofenced area; or the host vehicle being set in a specific vehicle operating mode (e.g., manufacturing mode, fleet override mode, long-term remote approval, etc.).

Upon corroborating the existence of a valid triggering event, the vehicle system automatically enables external control to be taken by a third party outside the vehicle and indicates to the external party the mode being activated with visual and audible indications. The vehicle control system collaborates with an on-vehicle network of sensors, such as cameras, motion sensors, and microphones, to receive visible or audible cues, such as predefined gestures (e.g., “secret” combinations of hand motions), verbal instructions (e.g., preset passwords or designated words), preassigned QR codes (e.g., dynamically downloaded from a command center), or in-vehicle approvals through buttons or displays. Under predefined conditions, the vehicle control system may receive remote approval from a command center to enable external control. Remote Control mode may be initiated in various ways, such as the host vehicle contacting a command center agent for approval, the command center contacting the host vehicle to initiate approval, a third party contacting the command center and providing proof of ownership or authority, or a command center agent contacting the third party, e.g., after attempting to enter manual mode but exceeding a number of invalid attempts. Once an external control mode is entered, the host vehicle may respond to valid commands and reject invalid commands (e.g., if unrecognized or deemed unsafe or illegal). The host vehicle may output visible/audible notification to the user for invalid commands. The system may time out (e.g., remotely or by default) if no further commands are received or a threshold number of invalid commands are received; the system will automatically notify the command center and exit the control mode. A general intent of at least some disclosed concepts is to provide controlled delegation of commanding authority of a vehicle to a human or non-human operator irrespective of their state of occupancy of the vehicle.

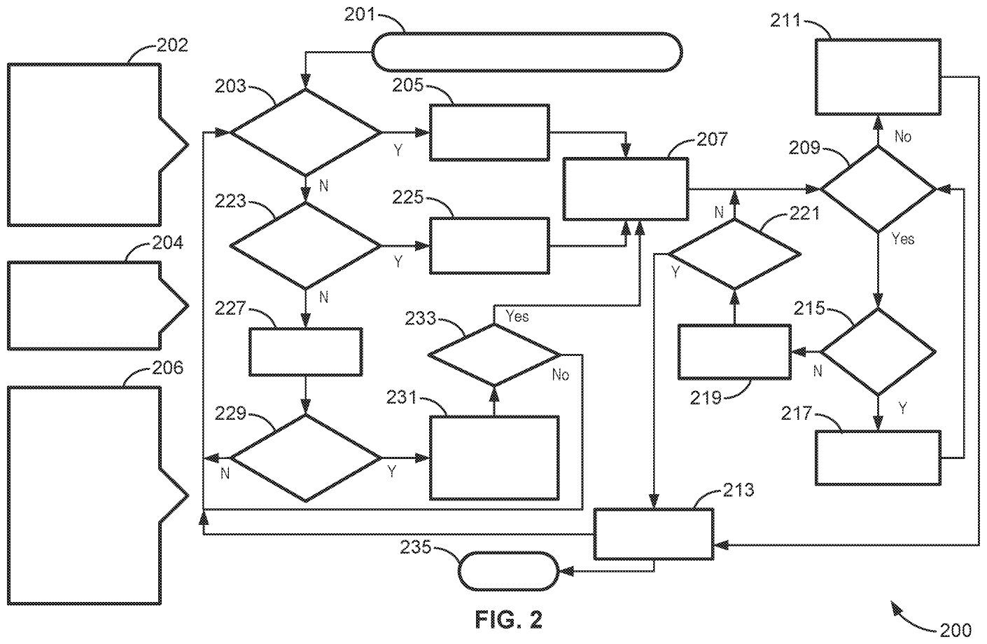

With reference next to the flow chart of FIG. 2, an improved method or control strategy for provisioning external control of a motor vehicle, such as automobile 10 of FIG. 1, via an entity outside of yet proximal to the vehicle is generally described at 200 in accordance with aspects of the present disclosure. Some or all of the operations illustrated in FIG. 2 and described in further detail below may be representative of an algorithm that corresponds to non-transitory, processor-executable instructions that are stored, for example, in main or auxiliary or remote memory (e.g., memory device 38 and/or database 98 of FIG. 1), and executed, for example, by an electronic controller, processing unit, dedicated control module, logic circuit, or other module or device or network of modules/devices (e.g., CPU 36 and/or cloud computing service 24 of FIG. 1), to perform any or all of the above and below described functions associated with the disclosed concepts. It should be recognized that the order of execution of the illustrated operation blocks may be changed, additional operation blocks may be added, and some of the herein described operations may be modified, combined, or eliminated.

Method 200 begins at START terminal block 201 of FIG. 2 with memory-stored, processor-executable instructions for a programmable controller or control module or similarly suitable processor to call up an initialization procedure for an Obedience Mode protocol. This routine may be executed in real-time, near real-time, continuously, systematically, sporadically, and/or at regular intervals, for example, each 10 or 100 milliseconds during operation of the motor vehicle 10. As yet another option, terminal block 201 may initialize responsive to a user command prompt (e.g., via telematics input controls 32), a resident vehicle controller prompt (e.g., via CPU 36), or a broadcast prompt signal received from an “off-board” centralized vehicle services system (e.g., BO cloud computing service 24). By way of example, and not limitation, method 200 may be initialized by a host vehicle controller in response to monitoring for and detecting any one of an assortment of obedience mode command triggers. Non-limiting examples of potential command triggers are enumerated above and are illustrated in FIG. 2 in Automatic Trigger data file 202, Manual Trigger data file 204, and Remote Trigger data file 206, each of which is described in further detail below. Upon completion of some or all of the control operations presented in FIG. 2, the method 200 may advance to END terminal block 235 and temporarily terminate or, optionally, may loop back to terminal block 201 or decision block 203 and run in a continuous loop.

Advancing from terminal block 201 to AUTOMATIC TRIGGER decision block 203, the method 200 determines whether or not an automatic trigger is received that automatically enables external control of the host vehicle using visible/audible commands. Memory-stored Automatic Trigger data file 202 denotes that an automatic trigger may include a vehicle controller (e.g., telematics unit CPU 36) receiving one or more sensor signals indicating: (1) an SOS/collision call was made to/from the host vehicle; (2) an airbag/seatbelt pretensioner/near deployment event was sensed within the host vehicle; (3) a thermal runaway propagation event is predicted or was detected within the host vehicle's RESS; (4) a real-time or near real-time location of the host vehicle is within a designated geofence; and/or (5) the host vehicle operating mode is set to a “pre-sale” or “pre-shipping” mode (e.g., in OEM, dealer, or rental lot/garage/warehouse/etc.). It should be appreciated that the herein described automatic, manual, and/or remote triggers may include greater, fewer, or alternative triggers than those presented.

Upon receiving any one of the predefined automatic triggers (Block 203=YES), method 200 proceeds to AUTOMATIC CONTROL MODE predefined process block 205 and activates an automatic control mode that enables an entity outside of the host vehicle to control predetermined operations of the vehicle using one or more visible and/or audible cues. The automatic control mode may enable a restricted (first) set of vehicle operations, each of which may be elicited by a respective visible or audible cue received from the external entity. Because preauthorization of the external entity may not be mandatory due to the exigent nature of an automatic control trigger, the memory-stored set of vehicle operations associated therewith may be restricted to just those vehicle control operations deemed necessary to protect the host vehicle and its occupants. It is envisioned that the host vehicle may solicit commands from or provide command options to the external entity.

Upon activation of an external control mode, method 200 may execute EXTERNAL CONTROL CONFIRMATION process block 207 and provide visual/audible confirmation to the external entity that external control is activated and the host vehicle is ready to receive commands. For instance, telematics unit CPU 36 may activate automatic control mode (Block 205), manual control mode (Block 225), or remote control mode (Block 231) and concomitantly command a vehicle subsystem of the host vehicle to output a predefined visible and/or audible confirmation indicating an external control mode is now active (Block 207). To this end, an activation signal may be transmitted to a host vehicle light system (e.g., front turn signals, headlamps, etc.) to generate a predefined light pattern (e.g., headlamps flash twice) or to a host vehicle audio system (e.g., car horn or audio system) to generate a predefined sound pattern (e.g., horn honks twice) or verbal confirmation (passenger cabin speakers output “EXTERAL CONTROL ACTIVATED!”).

With continuing reference to FIG. 2, method 200 advances from process block 207 to COMMAND DETECTION decision block 209 to determine whether or not a control command is received by the host vehicle from the external entity. In a non-limiting example, the vehicle controller (e.g., CPU 36 of FIG. 1) may communicate with an on-vehicle network of sensing devices (e.g., microphone 28, digital camera(s) 62, range sensor(s) 64, etc.) to detect any visible and/or audible cues input by the external entity. If the external entity does not input a visible/audible cue or they do so in a manner or from a location that renders the cue undetectable by the host vehicle, decision block 209 may conclude that a control command was not received. As a further option, activation of an external control mode (Blocks 205, 225 or 231) may commence a timer (e.g., using real-time clock (RTC) 42); decision block 209 may then monitor this timer to determine whether or not the on-vehicle network of sensing devices detects a visible/audible cue within a preset timeframe (e.g., maximum two (2) minute window). In this example, the vehicle controller may respond to the non-detection of a visible/audible cue within the preset timeframe by concluding that a visible or audible cue was not received. If no command is received (Block 209=NO), method 200 executes NO COMMAND TIMEOUT block 211 and sets a flag in cache memory that neither an audible nor a visible command was detected, and then executes EXTERNAL CONTROL DISABLED predefined process block 213 and disables the previously activated external control mode.

If a sensor-detectable command is received from the external entity (Block 209=YES), method 200 responsively executes VALID COMMAND decision block 215 to determine whether or not the detected visible/audible cue is any one of multiple preset valid commands. As an example, the digital camera(s) 62 may detect a first responder signaling with their right arm and hand for the host vehicle to move to the shoulder of the road; sensor signals indicative of these hand gestures are transmitted to the CPU 36 for processing and evaluation. The CPU 36 may compare the detected hand gesture to a preset list of valid commands—the restricted set of vehicle operations—which may be enumerated in a memory-stored lookup table assigned to the automatic control mode. If the detected hand gesture corresponds to one of the valid commands listed in the vehicle operation set, the CPU 36 concludes that a valid command was in fact received (Block 215=YES). Consequently, the method 200 automatically triggers EXECUTE COMMAND process block 217 to transmit one or more command signals to a necessary resident vehicle subsystem or subsystems of the host vehicle to automate the vehicle operation that corresponds to the preset valid command associated with the detected cue. At this juncture, the method 200 may loop back to decision block 209 and monitor for additional command inputs; otherwise, the method 200 may disable the external control mode at predefined process block 213 and then temporarily terminate at terminal block 235.

Upon determining that the detected external command cue is not recognized as one of the preset valid commands (Block 215=NO), method 200 responsively effects COMMAND FAILURE NOTIFICATION process block 219. Process block 219 may provide computer-readable instructions that cause the host vehicle to provide a predetermined visual/audible output to the external entity that indicates that the received command is an invalid command or a rejected command. It may be desirable that the visual/audible outputs implemented at process block 219 (e.g., single honk of horn or single flash of both front turn signals) be distinct from the visual/audible outputs implemented at process block 207 (e.g., double honk of horn or double flash of front headlamps). At this juncture, the method 200 may loop back to decision block 209—and any of the situation-pertinent processes blocks downstream therefrom—at which the vehicle controller communicates with the networked sensing devices to receive additional (new) sensor signals indicating detection of additional (new) cues from the external entity.

Before looping back to decision block 209 from process block 219, the method 200 may optionally execute FAILED THRESHOLD decision block 221 to determine whether or not the external entity has exceeded a predefined maximum number of attempts at inputting a valid command. By way of non-limiting example, activation of an external control mode at process blocks 205, 225, or 231 may concurrently initialize an invalid command counter that is built into the control algorithm. After automatic control mode is enabled at process block 205, for example, the external entity may be afforded five (5) attempts to enter a valid command before the system disengages automatic control. Optionally, a distinct number of attempts may be set in relation to severity of the situation or the purpose of vehicle control (e.g., afforded more attempts during an urgent situation than during a non-urgent situation). It is also envisioned that the number of attempts may be dynamically adjusted by the vehicle control system or BO host vehicle service based on vehicle sensor feedback, contextual data, vehicle state, remote user identify, etc. Upon determining that the external entity has exceeded its allotted maximum number of command attempts (Block 221=YES), method 200 responsively deactivates the external control mode at block 213. Conversely, if the entity has not exceeded their allotted maximum number of command attempts (Block 221=NO), method 200 loops back through process block 209.

Turning back to process block 203 of FIG. 2, method 200 may respond to not receiving a predefined automatic trigger (Block 203=NO) by executing MANUAL TRIGGER decision block 223 to determine whether or not a manual trigger is received to manually enable external control of the host vehicle. Memory-stored Manual Trigger data file 204 denotes that a manual trigger may include a vehicle controller (e.g., telematics unit CPU 36) receiving one or more sensor signals indicating: (1) detection of a predefined “specialized” gesture or gesture sequence; (2) scanning of a quick-reference (QR) code, barcode, data matrix code, NFC or RFID fob, or other scannable or detectable hand-held article assigned to a specific level of access; and/or (3) receipt of in-vehicle approval from a driver or occupant of the host vehicle. Other examples of potential “manual” triggers may include the vehicle controller and on-vehicle sensor network cooperatively identifying a recognized user pattern (e.g., EMS or law enforcement uniform, helmet, or badge), rank, special badge, biometric characteristics, etc.

Upon receiving at least one of the predefined manual triggers (Block 223=YES), method 200 proceeds to MANUAL CONTROL MODE predefined process block 225 and activates a manual control mode that enables an entity outside of the host vehicle to control predetermined operations of the vehicle using one or more visible and/or audible cues. The manual control mode may enable a less restricted (second) set of vehicle operations, each of which may be elicited by a respective visible or audible cue received from the external entity. Because some form of preauthorization of the external entity is requested to enable manual control, the memory-stored set of vehicle operations associated therewith may afford more vehicle control operations than those provided for automatic control. Comparable to the automatic control mode, however, the number and type of vehicle operations available during external vehicle control may be increased or decreased based on situation-specific data (e.g., the level of preauthorization provided).

If neither an automatic trigger nor a manual trigger is received (Block 203=NO && Block 223=NO), method 200 responsively executes TRIGGER FAILURE NOTIFICATION process block 227 and thereby causes the host vehicle to provide a predetermined visual/audible output that is designed to notify the external entity that a valid trigger was not received or a received trigger is deemed invalid. It may be desirable that the visual/audible outputs implemented at process block 219 (e.g., single honk of horn or single flash of both front turn signals) be distinct from the visual/audible outputs implemented at process block 227 (e.g., three quick honks of horn or flashes of headlamps) to help ensure that the external entity is able to demarcate between these notifications.

Method 200 of FIG. 2 continues from process block 227 to REMOTE TRIGGER decision block 229 to determine whether or not a remote trigger is received to remotely enable external control of the host vehicle. Memory-stored Remote Trigger data file 206 denotes that a remote control request trigger may include a vehicle controller (e.g., telematics unit CPU 36) receiving one or more sensor signals indicating: (1) a call was placed by an occupant or controller of a host vehicle to a BO host vehicle service (also referred to herein as “vehicle command center”); (2) a call was placed by an external entity or other third party to the BO host vehicle service; (3) a call was received by the host vehicle from the BO host vehicle service; and/or (4) the received manual triggers were recognized but not approved and authorization for external control is being requested. In general, remote control approval may necessitate some form of “off-board” permission process or the centralized command center taking control of the host vehicle or authorizing external control for a local third party. Upon determining that the remote control attempt was unsuccessful (Block 229=NO), method 200 may loop from decision block 229 back to terminal block 201 or decision block 203 or may temporarily end at terminal block 235.

After receiving at least one remote control trigger (Block 229=YES), method 200 proceeds to REMOTE CONTROL MODE predefined process block 231 and activates a remote control mode in response to remote approval to enable a vehicle command center and/or an entity outside of the host vehicle to control predetermined operations of the vehicle. The remote control mode may enable an expanded (third) set of vehicle operations, each of which may be elicited by a respective visible or audible cue received from the external entity. Because enhanced preauthorization of the external entity is requested to enable remote control, the memory-stored set of vehicle operations associated therewith may afford more vehicle control operations than those provided for manual control mode. In addition to or as an alternative for authorizing control of an external entity, remote control of the host vehicle may be subsumed by the vehicle command center. For example, method 200 may execute REMOTE CONTROL APPROVED decision block 233 to determine whether or not an external entity may take over vehicle control using visible/audible cues. If so (Block 233=YES), method 200 advances to process block 207; otherwise, the method 200 may respond to a denial of remote control (Block 233=NO) by disabling external control mode at process block 213.

In some non-limiting examples, herein described visible cues may include hand gestures, head motions, body movements, hand-drawn or hand-held signage, commands displayed via an electronic display, etc. In some non-limiting examples, herein described audible cues may include verbal commands, oral sounds (e.g., whistles), human-made sounds (e.g., claps, leg slaps, finger snaps, foot stomps), sounds output via an audio speaker, etc. As another option, any of the herein described external control modes may enable an external entity to execute a preset N number of commands (e.g., next five (5) commands preapproved by central command authority). Another option may include the ability to propagate a gesture-based command from a lead (first) vehicle to one or more coordinated (second, third, forth, etc.) vehicles in a formation. The control system may be programmed such that one or more commands may not be executed in predefined areas or may impose a higher authority of approval for activation. As yet another option, a wireless-enabled, third-party “talking” vehicle may be operable to connect to the host vehicle, e.g., using V2V comm protocols, to approve external control of the host vehicle or to act as a target vehicle followed by the host/surrogate vehicle.

In at least some embodiments, an intelligent vehicle control system may manage conflicting commands using overrides or cloud relays seeking intervention. If a command conflict cannot be resolved with either of the foregoing “default” protocols, the host vehicle may contact a BO vehicle command center for conflict resolution. As another option, an intelligent vehicle control system may indicate (e.g., via light, horn, wheel movement, etc.) a request for external control or a visible/audible command will necessitate an additional/supplemental “confirmation” to proceed, e.g., if the vehicle controller determines that a requested maneuver is risky or prohibited. If a threshold of identification is not met, the host vehicle may indicate that supplemental approval or an override is needed.

Aspects of this disclosure may be implemented, in some embodiments, through a computer-executable program of instructions, such as program modules, generally referred to as software applications or application programs executed by any of a controller or the controller variations described herein. Software may include, in non-limiting examples, routines, programs, objects, components, and data structures that perform particular tasks or implement particular data types. The software may form an interface to allow a computer to react according to a source of input. The software may also cooperate with other code segments to initiate a variety of tasks in response to data received in conjunction with the source of the received data. The software may be stored on any of a variety of memory media, such as CD-ROM, magnetic disk, and semiconductor memory (e.g., various types of RAM or ROM).

Moreover, aspects of the present disclosure may be practiced with a variety of computer-system and computer-network configurations, including multiprocessor systems, microprocessor-based or programmable-consumer electronics, minicomputers, mainframe computers, and the like. In addition, aspects of the present disclosure may be practiced in distributed-computing environments where tasks are performed by resident and remote-processing devices that are linked through a communications network. In a distributed-computing environment, program modules may be located in both local and remote computer-storage media including memory storage devices. Aspects of the present disclosure may therefore be implemented in connection with various hardware, software, or a combination thereof, in a computer system or other processing system.

Any of the methods described herein may include machine readable instructions for execution by: (a) a processor, (b) a controller, and/or (c) any other suitable processing device. Any algorithm, software, control logic, protocol or method disclosed herein may be embodied as software stored on a tangible medium such as, for example, a flash memory, a solid-state drive (SSD) memory, a hard-disk drive (HDD) memory, a CD-ROM, a digital versatile disk (DVD), or other memory devices. The entire algorithm, control logic, protocol, or method, and/or parts thereof, may alternatively be executed by a device other than a controller and/or embodied in firmware or dedicated hardware in an available manner (e.g., implemented by an application specific integrated circuit (ASIC), a programmable logic device (PLD), a field programmable logic device (FPLD), discrete logic, etc.). Further, although specific algorithms may be described with reference to flowcharts and/or workflow diagrams depicted herein, many other methods for implementing the example machine-readable instructions may alternatively be used.

Aspects of the present disclosure have been described in detail with reference to the illustrated embodiments; those skilled in the art will recognize, however, that many modifications may be made thereto without departing from the scope of the present disclosure. The present disclosure is not limited to the precise construction and compositions disclosed herein; any and all modifications, changes, and variations apparent from the foregoing descriptions are within the scope of the disclosure as defined by the appended claims. Moreover, the present concepts expressly include any and all combinations and subcombinations of the preceding elements and features.

What is claimed:

1. A method of controlling operation of a host vehicle having a vehicle controller and a network of sensing devices, the method comprising:
receiving, via the vehicle controller, an automatic trigger signal indicating the host vehicle is in any one of multiple predefined automatic control trigger states;
activating, via the vehicle controller responsive to receiving the automatic trigger signal, an automatic control mode enabling an external entity outside the host vehicle to control the host vehicle using visible and/or audible cues;
determining, via the vehicle controller, if the network of sensing devices detects a visible and/or audible cue from the external entity and outputs a sensor signal indicative thereof;
determining, via the vehicle controller responsive to receiving the sensor signal, if the detected visible and/or audible cue is a preset valid command; and
transmitting, via the vehicle controller responsive to the detected visible and/or audible cue being the preset valid command, a command signal to a resident vehicle subsystem of the host vehicle to automate a vehicle operation corresponding to the preset valid command.

2. The method of claim 1, further comprising:
receiving, via the vehicle controller from the network of sensing devices responsive to the detected visible and/or audible cue not being the preset valid command, a new sensor signal indicating detection of a new visible and/or audible cue from the external entity;
determining if the new visible and/or audible cue is the preset valid command; and
transmitting, via the vehicle controller responsive to the detected new visible and/or audible cue being the preset valid command, the command signal to the resident vehicle subsystem to automate the vehicle operation corresponding to the preset valid command.

3. The method of claim 1, wherein determining if the network of sensing devices detects the visible and/or audible cue includes determining whether or not the network of sensing devices detects the visible and/or audible cue within a preset timeframe, the method further comprising:
determining, via the vehicle controller responsive to the visible and/or audible cue not being detected within the preset timeframe, the visible and/or audible cue is not detected; and
deactivating, via the vehicle controller responsive to the determination that the visible and/or audible cue is not detected, the automatic control mode.

4. The method of claim 1, further comprising:
receiving, via the vehicle controller from the network of sensing devices after transmitting the command signal, a new sensor signal indicating detection of a new visible and/or audible cue from the external entity;
determining if the new visible and/or audible cue is any one of a plurality of preset valid commands; and
transmitting, via the vehicle controller responsive to the detected new visible and/or audible cue being one of the preset valid commands, a new command signal to the resident vehicle subsystem to automate a new vehicle operation corresponding to the one of the preset valid commands.

5. The method of claim 1, further comprising:
receiving, via the vehicle controller responsive to not receiving the automatic trigger signal, a manual trigger signal indicating the host vehicle received any one of multiple predefined manual trigger inputs; and
activating, via the vehicle controller responsive to receiving the manual trigger signal, a manual control mode, distinct from the automatic control mode, enabling the external entity to control the host vehicle using the visible and/or audible cue.

6. The method of claim 5, wherein the automatic control mode includes a first set of vehicle operations triggerable by the visible and/or audible cue from the external entity, and the manual control mode includes a second set of vehicle operations, different from the first set of vehicle operations, triggerable by the visible and/or audible cue from the external entity.

7. The method of claim 5, wherein the predefined manual trigger inputs include the host vehicle detecting a predefined gesture, detecting a preauthorized code, and/or receiving in-vehicle approval from an occupant of the host vehicle.

8. The method of claim 5, further comprising:
receiving, via the vehicle controller responsive to not receiving the automatic trigger signal and the manual trigger signal, a remote trigger signal indicating the host vehicle received approval for external vehicle control from a remote vehicle command center; and
activating, via the vehicle controller responsive to receiving the remote trigger signal, a remote control mode, distinct from the manual control mode and the automatic control mode, enabling the external entity to control the host vehicle using the visible and/or audible cue.

9. The method of claim 8, wherein the remote control mode further enables the remote vehicle command center to control the host vehicle using wirelessly transmitted control signals.

10. The method of claim 8, wherein the remote control mode includes a third set of vehicle operations, different from the first and second sets of vehicle operations, triggerable by the visible and/or audible cue from the external entity.

11. The method of claim 8, wherein the remote trigger signal is generated in response to communication between the remote vehicle command center and a wireless-enabled computing device of the external entity or a telematics unit or an advanced safety system of the host vehicle.

12. The method of claim 1, further comprising transmitting, via the vehicle controller responsive to activating the automatic control mode, an activation signal to a vehicle light and/or audio system of the host vehicle to output a predefined visible and/or audible confirmation indicating the automatic control mode is activated.

13. The method of claim 1, wherein the predefined automatic control trigger states include the host vehicle being in a collision state, the host vehicle or a vehicle operator being in an incapacitated state, and/or the host vehicle being positioned within a predefined location.

14. A non-transitory, computer-readable media storing instructions executable by one or more processors of a vehicle controller of a host vehicle having a network of sensing devices, the instructions, when executed by the one or more processors, causing the vehicle controller to perform operations comprising:
receiving an automatic trigger signal indicating the host vehicle is in any one of multiple predefined automatic control trigger states;
activating, responsive to receiving the automatic trigger signal, an automatic control mode enabling an external entity outside the host vehicle to control the host vehicle using a visible and/or audible cue;
receiving, from the network of sensing devices, a sensor signal indicating detection of the visible and/or audible cue from the external entity;
determining if the detected visible and/or audible cue is a preset valid command; and
transmitting, responsive to the detected visible and/or audible cue being the preset valid command, a command signal to a resident vehicle subsystem of the host vehicle to automate a vehicle operation corresponding to the preset valid command.

15. A motor vehicle, comprising:
a vehicle body;
a plurality of drive wheels rotatably attached to the vehicle body;
a prime mover attached to the vehicle body and operable to drive one or more of the drive wheels to thereby propel the motor vehicle;
a network of sensing devices attached to the vehicle body; and
a vehicle controller programmed to:
receive an automatic trigger signal indicating the motor vehicle is in any one of multiple predefined automatic control trigger states;
responsive to receiving the automatic trigger signal, activate an automatic control mode enabling an external entity outside the motor vehicle to control the motor vehicle using a visible and/or audible cue;
determine if the network of sensing devices detects the visible and/or audible cue from the external entity and outputs a sensor signal indicative thereof;
responsive to receiving the sensor signal, determine if the detected visible and/or audible cue is a preset valid command; and
responsive to the detected visible and/or audible cue being the preset valid command, command a resident vehicle subsystem of the motor vehicle to automate a vehicle operation corresponding to the preset valid command.

16. The motor vehicle of claim 15, wherein the vehicle controller is further programmed to:
receive, from the network of sensing devices responsive to the detected visible and/or audible cue not being the preset valid command, a new sensor signal indicating detection of a new visible and/or audible cue from the external entity;
determine if the new visible and/or audible cue is the preset valid command; and
responsive to the detected new visible and/or audible cue being the preset valid command, command the resident vehicle subsystem to automate the vehicle operation corresponding to the preset valid command.

17. The motor vehicle of claim 15, wherein the vehicle controller is further programmed to:
receive, from the network of sensing devices after commanding the resident vehicle subsystem to automate the vehicle operation, a new sensor signal indicating detection of a new visible and/or audible cue from the external entity;
determine if the new visible and/or audible cue is any one of a plurality of preset valid commands; and
responsive to the detected new visible and/or audible cue being one of the plurality of preset valid commands, command the resident vehicle subsystem to automate a new vehicle operation corresponding to the one of the plurality of preset valid commands.

18. The motor vehicle of claim 15, wherein the vehicle controller is further programmed to:
responsive to not receiving the automatic trigger signal, receive a manual trigger signal indicating the motor vehicle received any one of multiple predefined manual trigger inputs; and
responsive to receiving the manual trigger signal, activate a manual control mode, distinct from the automatic control mode, enabling the external entity to control the motor vehicle using the visible and/or audible cue.

19. The motor vehicle of claim 18, wherein the vehicle controller is further programmed to:
responsive to not receiving the automatic trigger signal and the manual trigger signal, receive a remote trigger signal indicating the motor vehicle received approval for external vehicle control from a remote vehicle command center; and
responsive to receiving the remote trigger signal, activate a remote control mode, distinct from the manual control mode and the automatic control mode, enabling the external entity to control the motor vehicle using the visible and/or audible cue.

20. The motor vehicle of claim 15, wherein the predefined automatic control trigger states include the motor vehicle being in a vehicle collision state, the motor vehicle being in a vehicle incapacitated state, and/or the motor vehicle being positioned within a predefined location.
